(19) United States
(12) Patent Application Publication
(10) Pub. No.: US 2009/0251524 A1
(43) Pub. Date: Oct. 8, 2009

(54) PULSED LASER MODE FOR WRITING LABELS

(75) Inventor: Johannes Leopoidus Bakx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,561

(22) PCT Filed: Dec. 19, 2005
(86) PCT No.: PCT/IB05/54310

§ 371 Date: Jun. 13, 2007

(30) Foreign Application Priority Data
Dec. 22, 2004 (EP) 04106855.2

(51) Int. Cl. B41J 2/435; H01S 3/00

(52) U.S. Cl. 347/224; 372/38.02

(57) ABSTRACT

An apparatus and a method for writing a label on a surface of an object, such as on the top surface of an optical disk (CD, DVD, Blu Ray etc.) are disclosed. The label is written by using the laser in the optical pickup unit of the disk device. The laser light is emitted as a pulse train in order to reduce the thermal load on the laser. The pulse train is provided by controlling the supply current of the laser, and the radiation power of the laser is reduced to zero between two successive sub-pulses of the pulse train by turning off the laser between successive sub-pulses.

The invention relates to an apparatus and a method for writing a label on a surface of an object, in particular the invention relates to an apparatus and a method that allows writing a visible label on the top surface of an optical disk by using the laser in the optical disk device.

Information about the content on a recordable optical disk, such as type of data, titles or other labels may be provided to the top surface by providing a sticker, e.g. labeled by a laser printer, onto the top surface. Alternatively, handwritten notes may be provided to nark the content on the optical disk.

The use of a sticker involves a printer and it may be tedious to provide a sticker with correct alignment to the top surface of an optical disk, whereas handwritten notes may not be appealing for aesthetic reasons.

In the published US application US2003/0161224 a method and apparatus are provided that allow a label to be formed directly on an optical disk by using a write laser mechanism with an optical disk drive. A special surface is needed in order to write the label.

A problem may arise for large dark areas of the label since the laser is switched on for a long time. This is critical with respect to heating since writing the label may take 20-40 minutes, depending on the image quality and size.

The inventor of the present invention has appreciated that the amount of heat generation during the creation of labels may be a problem, and has in consequence devised the present invention.

The present invention seeks to provide an improved apparatus and method of writing a label on a surface of an object. Preferably, the invention alleviates or mitigates one or more of the above or other disadvantages singly or in any combination.

Accordingly there is provided, in a first aspect, an apparatus for writing a label on a surface of an object, the apparatus comprising a radiation source controllable to emit light, and further comprising means to emit a radiation pulse train, the radiation pulse train being emitted so as to obtain a visible contrast or color change in a predetermined area element on the object, and further comprising means to emit a multitude of radiation pulses so as to induce a visible contrast or color change in a multitude of area elements.

The apparatus may comprise or may be an optical drive system, such as a system using a radiation source such as laser, or more specifically such as a diode laser, reading and/or recording data to a data storage medium. The object may be such an object as a data storage medium, including such media as a recordable CD-disks, DVD-Disks, Blu Ray-disk, etc.

The object may be provided with a top surface adapted to interact with the light emitted from the radiation source in such a way that a visible contrast or color change is induced in a predetermined area element on the object. The top surface of the object may be coated with one or more layers adapted, upon being exposed to energy in the form of light, to undergo a visual change, such as a visual contrast or color change. By providing a visible contrast or color change in a multitude of area elements a label, such as an image, may be provided. The label may be a monochrome label, a grey-scale label or a color label depending upon the surface of the object and depending upon how the radiation source is driven.

The resolution of the label may be correspond to spot size of the emitted light, the resolution may range from 0.5 to 25 micron, such as from 1 to 15 micron, such as from 5 to 10 micron.

The element may be provided with the visible contrast or color change by emitting a radiation pulse train. It is an advantage to emit a radiation pulse train to induce a visible contrast or color change, since the thermal load of the radiation source may be reduced as compared to emitting a single pulse of the same, or comparable, width as the pulse train.

The radiation power of the radiation source may be reduced below a specific threshold between two successive sub-pulses in the pulse train, and especially the radiation power may be reduced to zero or to a value close to zero. The radiation power may be controlled by controlling the supply current of the radiation source. Specifically, the radiation source may be turned off for a specific period of time between two successive sub-pulses in the pulse train.

It is an advantage to reduce the radiation power to zero or to a value close to zero between two successive sub-pulses by turning off the radiation source for a predetermined time between two successive sub-pulses, since the thermal load is reduced the most by turning off the radiation source.

The shape of the sub-pulses in a pulse train may be such that the pulse train may comprise substantially square sub-pulses of a duration Tₒₙ and separated by a duration T_{off}. Alternatively, the pulse train may comprise sub-pulses of variable heights. The variable height of the sub-pulses may e.g. be obtained by a duty-cycle modulation of the radiation pulse train.

It is an advantage to provide an apparatus with a large freedom in the appearance of the pulse train, in order to provide a versatile apparatus which may be adapted to various different types of surfaces on which the label may be created.

According to a second aspect of the present invention a method of operating an optical drive system to write a label on a surface of an object is provided. The system comprising a radiation source controllable to emit light, wherein at least a first radiation signal is emitted so as to obtain a visible contrast or color change in an element in a predetermined area on the object by emitting a radiation pulse train, and wherein a multitude of radiation pulses can be emitted so as to induce a visible contrast or color change in a multitude of elements.

The method may be implemented either by software, firmware or hardware in an apparatus according to the first aspect of the invention in order for controlling the apparatus in a manner so as to reduce the thermal load of the radiation source.

The visible contrast or color change in an elements may be induced by converting an image of the label into a time sequence corresponding to a passage of the radiation source of a given element for a predefined movement of the object, and wherein the time sequence is provided to a controller of the radiation source, so that the radiation source emits a pulse train during the passage of an element wherein a visible contrast or color change is to be induced, and wherein the radiation source is turned off during the passage of an element wherein the no visible contrast or color change is to be induced.

It is an advantage to provide the label according to this method since the method may be implemented by controlling the supply current of the radiation source as well as a controlled movement of the object and/or radiation source. In standard optical drives a controlled movement of the optical disk and the laser is already provided for, and only a control of the supply current may be needed. Such control may be implemented by providing control software to already existing optical drives.

The apparatus may be or may be part of an optical data storage system. The data storage system may include an optical pickup unit (OPU), wherein the data storage medium is an optical disk inserted into a disk drive, and wherein the label is provided to the optical disk by means of the radiation source present in the optical pickup unit by inserting the disk upside down into the drive. Alternatively, an additional radiation source may be provided on the opposite side of the OPU, in this way a label may be created on the top side of a disk irrespectively of whether the OPU is in use for reading or recording data from or on the disk.

It is an advantage to provide the apparatus in a standard type of optical drive.

These and other aspects, features and/or advantages of the invention will be apparent from and elucidated with reference to the embodiments described hereinafter. Embodiments of the invention will be described, by way of example only, with reference to the drawings, in which

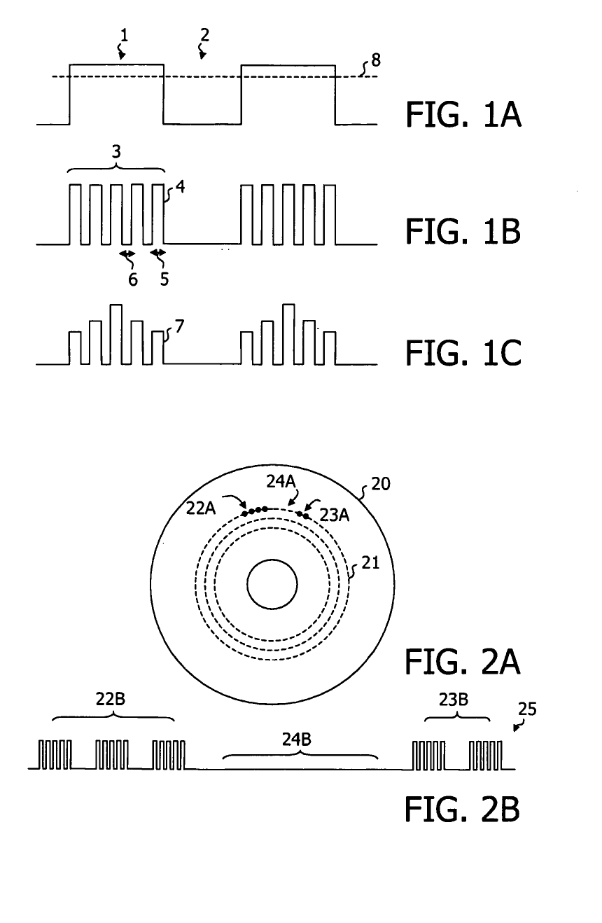

FIG. 1 illustrates modes of driving the laser,

FIG. 2 illustrates an embodiment of a method of applying the present invention.

Preferred embodiments are hereafter described wherein the apparatus for writing the label on a surface of an object, is an optical disk drive comprising a laser, and wherein the object is a such as a CD or DVD disk, and wherein the label provided is a monochrome label.

A visual change may be applied to the surface of a disk by provided a disk with a surface with the ability of undergoing a visible contrast or color change when a certain amount of light is provided to the surface. The surface may be coated with one or more layers exhibiting such an ability upon interaction with light, e.g. by changing chemical composition, change chemical structure etc.

In order to provide a visual change in a predefined area, the laser may be driven as illustrated in FIG. 1A, which illustrates the current supplied to the laser, thus the laser emits light I when receiving current above a certain threshold 8 and does not emit light 2 for a supply current below the threshold 8. Thus for the supply current illustrated in FIG. 1A two areas would be provided with a visual change (a black dot), separated by a blank area (a white dot).

However, driving the laser as illustrated in FIG. 1A may generate a critical heating of the laser in dark areas. By driving the laser as illustrated in FIG. 1B, the same visible change on the surface of the disk may still be provided, but the thermal load of the laser is reduced. FIG. 1B illustrates a laser supply current in the form of pulse trains, where the laser is turned off between two successive sub-pulses in the pulse trains as well as between successive pulse trains. The pulse train is characterized by a sub-pulse duration 5 Tₒₙ. and a separation time 6 of the sub-pulses T_{off}, where the laser is turned off. The time constants Tₒₙ. and T_{off} may be adjusted in accordance with the necessary amount of energy to be supplied during the pulse train.

In an optical drive when recording data on a recordable medium, the writing speed is very high with a time separation between writing the individual data elements in the nanosecond range. Since the lasers that are used to write the data on the recordable medium suffers from a finite rise time, e.g. it takes a certain amount of time between turning on the laser and until maximal emission is achieved, the lasers are driven with a current modulation around the emission threshold of the laser, in this way the laser may flip between emission and no emission very fast. In this way however, the laser is constantly supplied with current resulting in heat generation.

In order to provide sufficient light to a specific element on the top surface of a disk to induce a visual change, it is necessary to rotate the disk very slowly, such as with a rotational speed of only 0.2 to 0.4 m/s, more than 10 times slower than in the data recording mode.

With such low rotational speeds, the rise time of the laser is not crucial, and consequently the laser may be turned off between the sub-pulses in the pulse train. The turning off of the supply current of the laser reduces the overall temperature during the writing of a label.

The shape of the sub-pulses may vary e.g. by modulating the height 7 of the individual sub-pulses, e.g. by means of a duty cycle modulation.

The time constants Tₒₙ. and T_{off} may be chosen depending upon the characteristics of the laser, the medium, and the diameter of the radiation spot at the label. This diameter is typically 10 μm, so at a linear medium speed of 0.4 m/s, the disk must travel 25 μs before the spot completely passes a certain point. If a value of Tₒₙ. <25 μs is chosen, e.g. Tₒₙ=5 μs, a value of T_{off =}20 μs should be chosen if the entire spot diameter contributes to the writing process. These numbers result in a significant power reduction. By taking Tₒₙ still smaller, even more reduction would be obtained. But in this case, it becomes difficult to switch the laser current all the way to zero and still have sharp pulses. Also the maximum peak power of the laser should not be obtained. A possible criterion of how to chose the time constants may be to take Tₒₙ as small as possible without jeopardizing the maximum peak power and the pulse form. Next T_{off} is taken as large as possible while still producing a continuous line of dots.

In FIG. 2 the principle of providing a label to the top side of a disk 20 is illustrated. Many different types of labels may be provided, such as text and images.

The user may compose a desired label e.g. by using a dedicated software application, such a label may be stored in a bitmap format, such as a bmp-format or jpg-format. These formats are Cartesian formats where a 2D grid is defined and to each grid element a value is assigned representing whether or not the element is filled, such a “1” for a black dot and “0” for a white dot. To provide the label to the laser controller, the image may be transformed into a polar type coordinate system. A disk grid consisting of concentric circles may be defined as illustrated in FIG. 2A. On each grid a number of elements, such as pixel elements are defined. For the inner most circle N elements may be present along the circle, whereas for the next circle M elements may be present, where M>N, since the circumference of the concentric circles increases outwardly from the center. The number of pixel elements may correspond to the circumference divided by the laser spot diameter. Thus a pixel element on the Cartesian representation of the label may be transformed into a polar type coordinate system with one coordinate referring to the specific concentric circle and a second coordinate referring to the number of the element on the circle.

The movement of the laser across the surface of the disk is known since the geometric aspects of the system are well defined and the rotational speed is known. Therefore the polar-type representation of the label may be transformed into a time sequence where a pulse train is provided when the laser passes the element to be provided with a black dot. This time sequence may advantageously be fixed to the system clock, the system clock being the master clock of the electronic of the system. The system clock is locked to a spoke pattern on the disk, which is read by a special sensor in the drive. This provides very accurate speed control and pixel placing.

In FIG. 2A three concentric circles representing three grid circles are illustrated. On the outer most grid circle 21 three consecutive elements is to be colored 22A and a blank section 24A separates two elements also to be colored 23A. In FIG. 2B is illustrated the supply current 25 provided to the laser corresponding to the passage of the section on the disk, where first three consecutive pulse trains 22B are provided, then a blank section where the laser is maintained off 24B and subsequently the two consecutive pulse trains 24B. In this way an entire image may be provided to the disk.

Only the monochrome labels have been described, it is however within the capability of the skilled person to extend also to providing a grey-scale label, e.g. by using a raster type coloring of the elements. In order to provide a color label the top surface of the disk should be adapted to exhibit a color change upon interaction with light.

Although the present invention has been described in connection with preferred embodiments, it is not intended to be limited to the specific form set forth herein. Rather, the scope of the present invention is limited only by the accompanying claims.

In this section, certain specific details of the disclosed embodiment such as specific devices, pulse shapes, etc., are set forth for purposes of explanation rather than limitation, so as to provide a clear and thorough understanding of the present invention. However, it should be understood readily by those skilled in this art, that the present invention may be practiced in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. An apparatus for writing a label on a surface of an object (20), the apparatus comprising a radiation source controllable to emit light, and further comprising means to emit a radiation pulse train (3,7), the radiation pulse train being emitted so as to obtain a visible contrast or color change in a predetermined area element on the object (22A, 23A), and further comprising means to emit a multitude of radiation pulses so as to induce a visible contrast or color change in a multitude of area elements.

2. An apparatus according to claim 1, wherein the radiation power of the radiation source is zero between two successive radiation sub-pulses of the pulse train.

3. An apparatus according to claim 1, wherein the pulse train comprises substantially square sub-pulses (4,7) of a duration Tₒₙ. (5) and separated by a duration T_{off} (6).

4. An apparatus according to claim 1, wherein the pulse train comprises sub-pulses of variable heights.

5. An apparatus according to claim 4, wherein a variable height of the sub-pulses is obtained by a duty-cycle modulation of the radiation pulse train.

6. Method of operating an optical drive system to write a label on a surface of an object, the system comprising a radiation source controllable to emit light, wherein at least a first radiation signal is emitted so as to obtain a visible contrast or color change in an element in a predetermined area on the object by emitting a radiation pulse train, and wherein a multitude of radiation pulses can be emitted so as to induce a visible contrast or color change in a multitude of elements.

7. Method according to claim 6, wherein the visible contrast or color change in an elements is induced by converting an image of the label into a time sequence (25) corresponding to a passage of the radiation source of a given element for a predefined movement of the object, and wherein the time sequence is provided to a controller of the radiation source, so that the radiation source emits a pulse train during the passage of an element (22A, 23A) wherein a visible contrast or color change is to be induced, and wherein the radiation source is turned off during the passage of an element (24A) wherein the no visible contrast or color change is to be induced.

8. An optical data storage system according to claim 1, the data storage system including an optical pickup unit, wherein the data storage medium is an optical disk inserted into a disk drive, and wherein the label is provided to the optical disk by means of the radiation source present in the optical pickup unit.

9. Use of a radiation pulse train to induce a visible contrast or color change in an area element on a surface of a data storage medium.
